(19) United States
(12) Patent Application Publication
(10) Pub. No.: US 2009/0299768 A1
(43) Pub. Date: Dec. 3, 2009

(54) APPARATUS AND METHOD FOR PREDICTING HEALTHCARE REVENUE CYCLE OUTCOMES AND CONTROLLING WORK FLOW

(76) Inventors: Jason Petrasich, Aliso Viejo, CA (US); Glenn K. Lew, Laguna Hills, CA (US); Dachuan T. Shih, Farmers Branch, TX (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/428,526

(22) Filed: Apr. 23, 2009

Related U.S. Application Data
(60) Provisional application No. 61/058,274, filed on Jun. 3, 2008.
(60) Provisional application No. 61/074,200, filed on Jun. 20, 2008.

(51) Int. Cl. G06N 5/02; G06Q 50/00; G06Q 40/00

(52) U.S. Cl. 705/3; 705/4; 706/46

(57) ABSTRACT

An outcome prediction model is generated and/or executed to predict an outcome of processing a healthcare patient account. As examples, these outcomes may relate to the payment of the healthcare patient account, to the timing of when payment of the healthcare patient account will be paid, to at least an initial denial of payment of the healthcare patient account, to payment of the healthcare patient account after a defined time period, and or to qualification of the patient for a government sponsored program regarding healthcare.

### RELATED APPLICATIONS

This application claims the benefit of U.S. Provisional Application 61/058,274 filed on Jun. 3, 2008 and of U.S. Provisional Application 61/074,200 filed on Jun. 20, 2008.

### TECHNICAL FIELD

The present disclosure relates to the prediction of healthcare revenue cycle outcomes, and/or to the control of work flow in optimally generating those outcomes. As an example, the present disclosure relates to predicting the timing of receiving payment from insurance carriers.

### BACKGROUND

In 2007, U.S. healthcare spending reached $2.3 trillion and accounted for 16% of the GDP. A study by Harvard Medical School and the Canadian Institute for Health Information determined that some 31% of U.S. healthcare dollars, or more than $1,000 per person per year, went to health care administrative costs.

Healthcare providers understand the burden of high health care administrative costs associated with the U.S. healthcare system and desire to reduce these costs wherever possible throughout the system. Historically, this cost reduction has been challenging because there are several thousand commercial insurance providers (payers), each with its own processes and behaviors.

Also, individual healthcare providers frequently enter into contracts individually with payers (e.g., insurance carriers) each of which has claim payment procedures tailored to its own policies. Thus, these procedures vary from payer to payer. This individualism causes each claim for payment to follow unique processes and procedures that may be different from every other claim.

This individualism of the claims process and the shear number of payers compound the administrative problems of healthcare providers resulting directly in higher administrative costs. Healthcare providers need the capability to analyze multiple factors associated with each individual patient account to predict the optimal process for account resolution at the lowest possible cost.

Additionally, a common practice in the U.S. healthcare industry is for payers to deny or withhold processing of claims for payment based on the payer's individual rules. Such rules might involve, for example, requiring additional documentation, following specific procedures, applying differing opinions on contract interpretation, mitigating payer loss, and/or detecting fraud.

Therefore, healthcare providers also need the capability to predict the likelihood of a non-payment event occurring on an individual claim, to predict the optimal resolution to the non-payment event, and/or to predict the likelihood of successfully overturning non-payment events.

Another consequence of the U.S. healthcare system is that insured patients subsidize uninsured patients. Federal law (EMTALA) requires hospital emergency rooms to treat all patients without regard to their ability to pay. Historically, providers recover only about 8 cents on the dollar from uninsured patients. The other 92 cents is a bad debt operating expense that must be offset by revenue from insured patients.

Providers need the capability to predict and identify patients who have the ability, and are likely, to pay some, or all, of their healthcare bill in order to maximize those collections and minimize administrative collection costs. Some portion of insurance-due accounts are also considered bad debt, and providers need the capability to predict the likelihood of collecting payment on such accounts.

Lastly, many states and local governments provide subsidized health care in the form of Medicaid, medical subsidies for indigent patients, and other programs. Also, some states require hospital providers to provide charity care to the community in order to qualify for additional subsidies. Collectively these are referred to as “government programs”. The healthcare providers' administrative costs for government programs are higher than for commercial insurance because the providers undertake the additional burden of assisting patients in qualifying and receiving eligibility. This process involves costly in depth financial analysis for each patient and assistance in completing required forms for submission to the government program.

Healthcare providers need the capability to predict the likelihood that a patient will qualify for a government program, as well as to predict the cooperativeness of patients in supplying the required information and forms to become eligible.

Methods, apparatus, and programs are disclosed herein to enable healthcare providers to address the challenges of reducing or minimizing healthcare administrative costs by predicting revenue cycle outcomes and/or optimizing resources based on the predictions.

In one embodiment of the processes disclosed herein, healthcare providers are enabled to predict the timing of a payment or non-payment from a payer (e.g., insurance carrier, patient, etc.) on an individual claim for payment. As an alternative or additional feature of this embodiment or other embodiments, healthcare providers are allowed to customize work processes for individual claims, thus reducing unnecessary labor and ultimately reducing administrative costs.

In another embodiment of the processes disclosed herein, healthcare providers are enabled to predict which accounts are likely to be paid by the patient at a specific point in the revenue cycle, such as but not limited to the point of service, the point of first bill to patient, the point of charge off to bad debt, and/or the point of secondary bad debt placement.

In still another embodiment of the processes disclosed herein, healthcare providers are enabled to predict which claims will receive a denial or non-payment from the payer. As an alternative or additional feature, healthcare providers are allowed to predict appropriate resolutions and to take corrective actions prior to receiving the non-payment. As a further alternative or additional feature, healthcare providers are able to predict the likelihood of overturning the non-payment (reversing the payer decision), and to prioritize resources based on that information.

In yet another embodiment of the processes disclosed herein, healthcare providers are enabled to predict which accounts are likely to be paid by an insurance payer after a defined period of time has lapsed since submission of the claim for payment.

In a further embodiment of the processes disclosed herein, healthcare providers are enabled to predict which patients will qualify for government programs and which patients will cooperate with the process. As an alternative or additional feature, healthcare providers are enabled to prioritize resources based on that information.

This disclosure enables future unspecified applications that deal with revenue cycle issues where predictive analytics and directed work processes would be beneficial to improving the process, increasing and/or accelerating cash flow, and reducing administrative costs.

### BRIEF DESCRIPTION OF THE DRAWING

Features, aspects, and advantages of these embodiments will become better understood when the following detailed description is read with reference to the accompanying drawings in which:

FIG. 1 is a flow chart of a computer implemented high level account management process;

FIG. 2 is a specific application of the process of FIG. 1 directed to predicting payment dates for accounts;

FIG. 3 is an example of a segment matrix discussed below;

FIG. 4 is a flow chart illustrating a computer implementation of the MicroSegmentation™ engine of FIGS. 1 and 2;

FIG. 5 is a flow chart illustrating a computer implementation of the workflow engine of FIGS. 1 and 2; and,

FIG. 6 illustrates a machine that executes the various processes described herein.

### DETAILED DESCRIPTION

Healthcare revenue cycle data from a plethora of patient accounts can be analyzed in order to generate a model (algorithm) that predicts future outcomes, such as which accounts will be paid or not paid, when accounts will be paid, which accounts will receive a denial of payment, which accounts will be paid after a defined period of time, which patients will qualify for government programs, etc. The model can then be executed for an individual patient account, the output of the executed model can be mapped to a population segment, and work flow rules can be applied based on the segment. According to one example, historical data is utilized to predict the number of days it will take an insurance payer to pay a particular claim upon submission, and to drive work processes based on that predicted date.

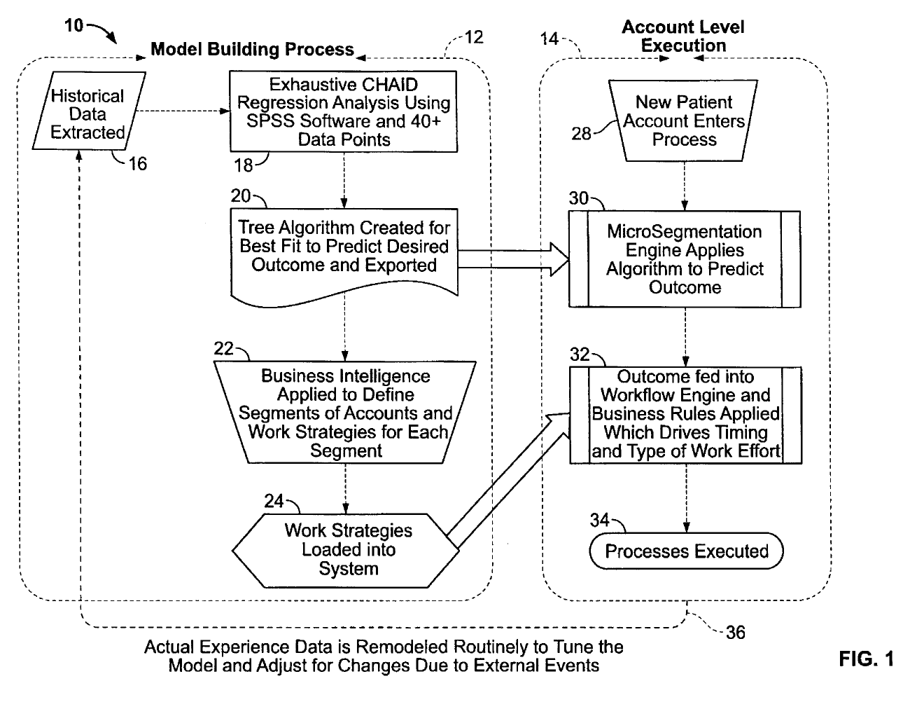

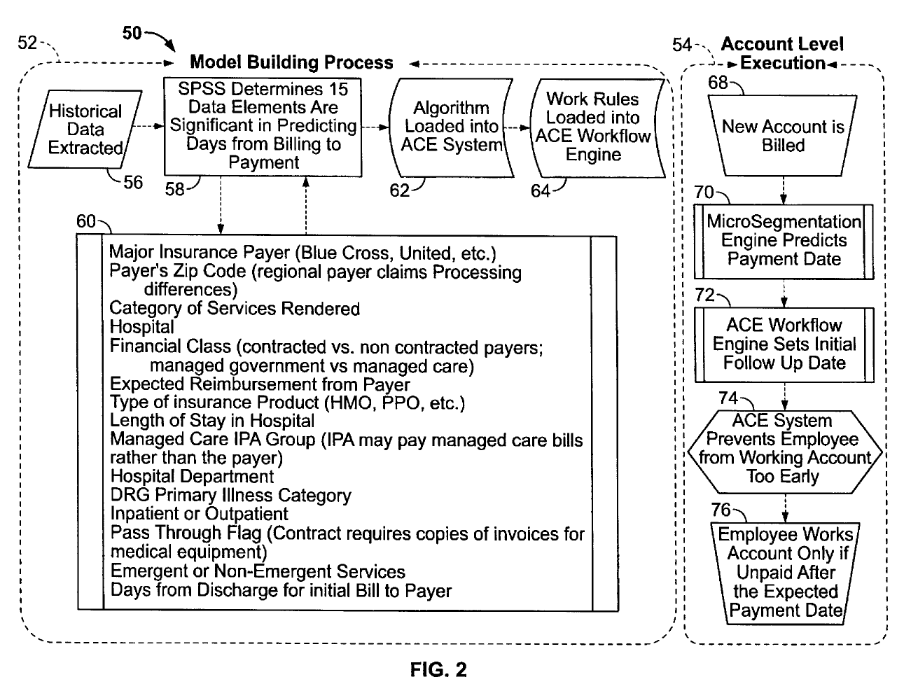

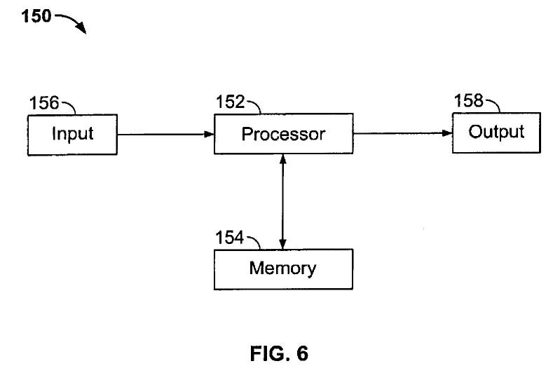

An account management process 10 is shown in FIG. 1 and involves two major components, a model building process 12 and an account level process 14. The account management process 10 executes on a machine such as a computer(s) including, for example, a processor(s) that executes the account management process 10, that receives input data from an input device(s) such as a mouse, a keyboard, etc., and that provides (predicted) outputs to an output device(s) such as a printer, a display, etc. The computer(s) may also have memory that stores the account management process 10 executed by the processor, input data, output data, etc. An example of such a computer is described below in connection with FIG. 6.

During the model building process 12, historical data and outcomes are extracted at a block 16. Examples of these historical data and outcomes include patient visit financial data, patient insurance data, patient historical financial data, patient visit clinical data, patient credit bureau data, U.S. Census block-level data, etc.

Patient visit financial data includes, but is not limited to, financial class, prior payments, dates of payments, account balance, employment, presence of contact information, provider of service, and days since discharge. Patient insurance data includes, but is not limited to, insurance payer, zip code of claims processing center, expected reimbursement from payer, payments, non-payments, reasons for non-payments, amount denied/unpaid, dates of payments and denials, and requirement of claims attachments. Patient historical financial data includes, but are not limited to, number of prior healthcare visits, and amounts paid on previous healthcare visits. Patient visit clinical data includes, but are not limited to, emergency vs. non-emergency service, inpatient vs. outpatient, length of stay, category of medical services provided, type of services provided, and diagnosis related group. Patient credit bureau data includes, but are not limited to, credit score, credit scoring reasons, presence of mortgage, and available credit card credit. U.S. Census block-level data includes, but are not limited to, percent of college graduates, average per capita income, average household income, percentage married, percentage homeowner, average home value, and percent family households.

At 18 of the account management process 10, the historical account-level data elements and outcomes are loaded into statistical software SPSS, and the statistical software SPSS executes an exhaustive CHAID analysis on the data points in the historical account-level data to derive a classification tree algorithm that predicts the desired outcome based on the statistically significant data entered at 16.

SPSS is software that may be licensed from SPSS Inc. CHAID is an exhaustive mathematical process that is utilized by SPSS. SPSS prompts the user to choose the outcomes (such as pay, don't pay, payment timing, and/or government program qualification) that the user is trying to predict and to choose the independent variables (such as age, sex, etc.) to test. The SPSS program includes parameters that can be adjusted. Such parameters include, but not limited to, the type of regression algorithm, the significance level for splitting nodes, the minimum number of nodes per case, and the maximum tree depth.

The user may run the SPSS program several times with adjustments to these parameters until the user is satisfied that an algorithm that best fits the historical data and outcomes extracted at 16 is found. Typically, the sample data is split into a population for training (building the model) and a population for testing (validating the model). Once the user is satisfied that the results for the training and testing populations are similar, the user can then proceed to the next step.

At 20, the classification tree algorithm is loaded in the account level process 14 as a prediction engine, which is a software application of the account level process 14. The prediction engine, for example, may be a MicroSegmentation™ engine.

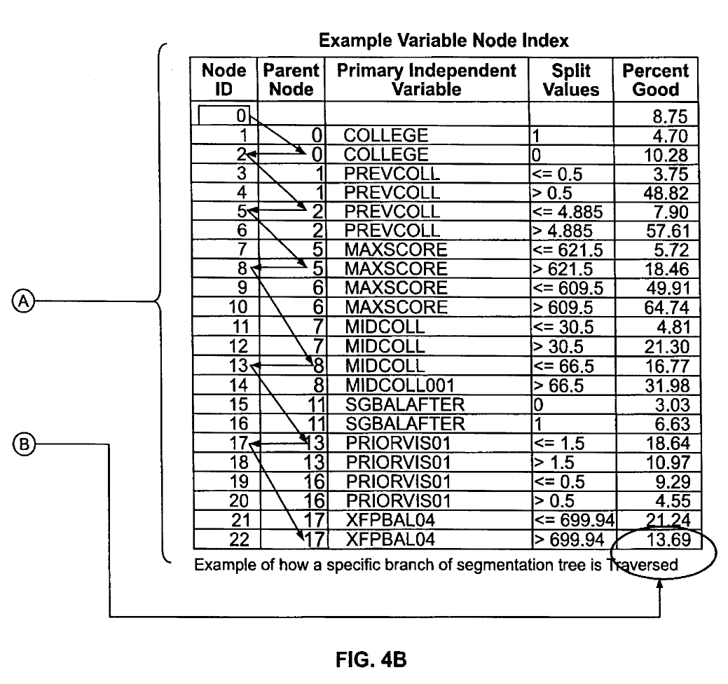

The table of FIG. 4 labeled “Example Variable Node Index” is an example of a specific branch of a segmentation tree. An example of traversing this branch begins at Node 0 (the “root” node). The engine determines which node to process next by checking each of that node's children (in Node ID order) to determine if any child's split value is satisfied. First, Node 1 is checked, but the split condition (COLLEGE=1) is not satisfied because the value of COLLEGE is 0 for the account. Second, Node 2 is checked, and it does satisfy the split condition (COLLEGE=0). Hence, Node 2 is processed next.

Treating Node 2 as the parent node, the engine checks its children (Nodes 5 and 6) to determine if the child's split value is satisfied. Because the split condition (PREVCOL<4.885) is satisfied for Node 5, the engine processes Node 5 next and it will not even check Node 6's split condition.

Treating Node 5 as the parent node, the engines checks its children (Nodes 7 and 8) to determine if any child's split value is satisfied. First, Node 7 is checked, but the split condition (MAXSCORE<=621.5) is not satisfied because the value of MAXSCORE is 700 for the account. Second, Node 8 is checked, and it does satisfy the split condition (MAXSCORE>621.5). Hence, Node 8 is processed next.

Treating Node 8 as the parent node, the engine checks its children (Nodes 13 and 14) to determine if any child's split value is satisfied. Because the split condition (MIDCOLL<=66.5) is satisfied for Node 13, the engine processes Node 13 next and it will not even check Node 14 split condition.

Treating Node 13 as the parent node, the engine checks its children (Nodes 17 and 18) to determine if any child's split value is satisfied. Because the split condition (PRIORVIS<=1.5) is satisfied for Node 17, the engine processes Node 17 next and it will not even check Node 18's split condition.

Treating Node 17 as the parent node, the engine checks its children (Nodes 21 and 22) to determine if any child's split value is satisfied. First, Node 21 is checked, but the split condition (XFPBAL<=699.94) is not satisfied because the value of MAXSCORE is 800 for the account. Second, Node 22 is checked, and it does satisfy the split condition (XFPBAL>699.94). Hence, Node 22 is processed next.

Treating Node 22 as the parent node, the engine checks its children to determine if any child's split value is satisfied. Because Node 22 is an end node and does not have any children, Node 22 contains the “mean” or “good percentage” that the account falls within the predicted classification.

The result of this processing yields the identification of a specific node that can be used to predict the classification of the account. The definition of the node includes the “mean” or “good percentage” (depending on the type of tree) that the account falls within the predicted classification.

Processes other than SPSS can be used to generate the input that is exported to the account level process 14.

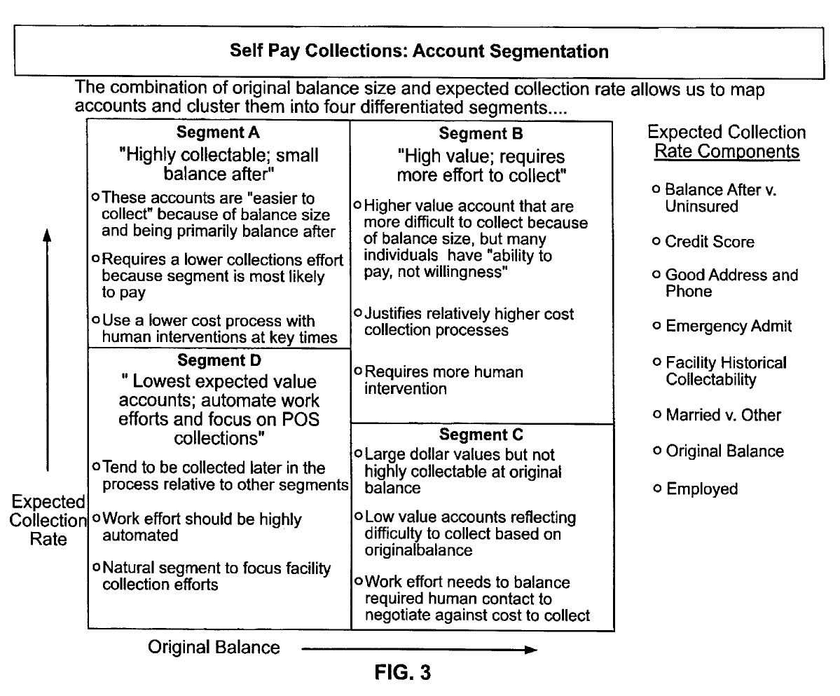

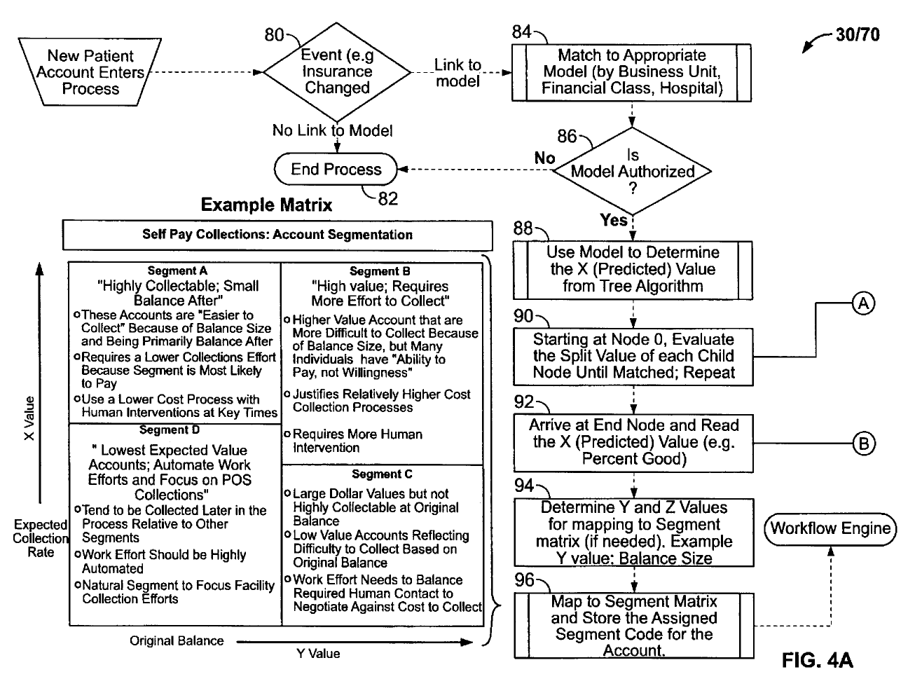

At 22, business intelligence is used to derive and define logical segments of the population. This business intelligence depends on the domain knowledge of the user in determining patterns in the data, or breaks in the data that make logical sense. For example, one segment might be for patients who have small bills and are likely to pay. A work strategy for this segment might be, in the case of patient bills, if the bill is small, and the patient is very likely to pay, it makes business sense (business intelligence) to send the patient or the patient's insurer a statement and to wait for payment, rather than to launch phone calls to try to collect the payment every few days. The phone calls would be “wasted” work effort (cost) because the patient is very likely going to pay anyway. Another logical segment might include, for example, patients or patient's insurers who are not likely to pay, in which case a different working strategy might be defined. This business intelligence is the collective expertise of employees of the user of the account management process 10 and is built from years of trial and error and discerning strategies that are successful. FIG. 3 shows an example of a segment matrix containing exemplary business intelligence.

The segments may form a 1-, 2-, or 3-dimensional segment matrix.

At 24, the work strategies based on this business intelligence defined at 22 are loaded as a work flow engine into the account level process 14. These work strategies, for example, can include sending letters, making phone calls, etc., and generally include activities that the healthcare provider wants to take place, the timing for such activities (e.g., day 12, day 22, etc.), and the attitude that should be portrayed during the corresponding activity (friendly, strong, etc.). Each of these work strategies is predicated upon the business intelligence and segments defined at 22.

The model building process 12 may be invoked to generate a plurality of classification tree algorithms (models). Each model is build in dependence upon the particular historical data extracted at 16, the outcomes (such as pay, don't pay, payment timing, and/or government program qualification) that the user desires to predict, the independent variables that the user chooses, and adjustments made to the parameters. The model building process 12 also may be invoked to generate a set of work strategies for each of the models. Alternatively, the model building process 12 may be invoked to generate a single model that covers all of the outcomes which the user desires to predict and to generate a single set of work strategies associated with that single model. Other combinations are possible.

As indicated above, the classification tree algorithm(s) derived at 18 and the logical population segment based work strategy set(s) generated at 24 are exported to the account level process 14. During the account level process 14, each new patient account entry is entered at 28 for processing to determine the likely outcome (e.g., whether payment is likely to be made and when, whether a payer will deny a claim, whether the patient will qualify for a government program, etc.) with respect to the new patient account entry.

The triggering event for new accounts to be processed beginning at 28 is identified. Triggering events include but are not limited to the creation of a new account, the submission of claim for payment to a payer, the receipt of a non-payment event, a change in financial class, and/or a change in responsible insurance payer.

At 30, the prediction engine applies the tree algorithm generated at 18 and imported from 20 in order to predict relevant outcomes. Thus, the processing of the account at 30 as initiated at 28 involves execution of the tree algorithm model in order to output the predicted percentage likelihood or mean value of a desired outcome. Execution of the tree algorithm at 30 involves mapping the outcome into a defined matrix to identify a segment, and storing the segment associated with each account. An example of a segment matrix is shown in FIG. 3.

The exemplary segment matrix of FIG. 3 has four segments, although a greater or lesser number of segments can be used. A combination of the balance size of an account and the expected collection rate allows accounts to be mapped and clustered into one of these four segments.

Highly collectible, small remaining balance accounts fall into segment A. These accounts are easier to collect because of the balance size and the small remaining balance after collection. They require little collection effort because accounts falling into this segment are likely to be paid. Thus, these accounts require lower cost processing and lower human intervention.

High value accounts with still fairly high collection rates fall into segment B. These higher value accounts are more difficult to collect because of the higher balance sizes of the accounts, although the individuals associated with these accounts have the ability to pay if not the willingness. Because these accounts have larger values, they justify relatively higher collection costs and effort. Thus, these accounts require higher cost processing and more human intervention.

High value accounts with lower collection rates fall into segment C. These higher value accounts are more difficult to collect. Because these accounts have larger values but lower collection rates, they require still higher collection costs and effort. Thus, these accounts require still higher cost processing and still more human intervention.

Low value accounts with low collection rates fall into segment D. These accounts tend to be collected later in the account process relative to the other segments. They require the most work effort to collect and, therefore, the work effort should be as highly automated as possible. This segment is a natural segment for which to focus facility collection efforts. Thus, work efforts should be automated and focus should be placed on point-of-sale collection.

At 32 of the account level process 14, the predicted outcome from 30 is supplied to the workflow engine that applies the work strategies from 24. The workflow engine applies business strategies to drive the timing and type of account processing effort. During processing at 32, the business strategies are loaded into the workflow engine of the account level process 14. Automated work events that reference the account's segment, such as controlling when an employee sees the account on his or her worklist, are triggered using event-criteria-action logic. The workflow decision engine is used to direct subsequent work process steps referencing the account's segment, whether automated or manual, including the timing of such events. For example, if a business strategy requires the sending of a letter to the patient on day 1, day 35, day 60 and day 92, this strategy is executed by the employee. The business strategies to achieve collections are tailored to each of the segments of the segment matrix.

Finally, at 34, the healthcare provider implements the account processing as directed at 32. This effort may involve processing accounts based on payment and non-payment timing predicted at 32, based on which accounts are likely to be paid by the patient at a specific point in the revenue cycle, based on which claims are likely to receive a denial or non-payment from the payer as predicted at 32, based on which accounts are likely to be paid by an insurance payer after a defined period of time has lapsed since submission of the claim for payment as predicted at 32, based on which patients will qualify for government programs and which patients will cooperate with the process as predicted at 32, etc.

Moreover, the actual experience that is derived from processing these accounts is fed back at 36 as additional historical data in order to update and refine the tree algorithm that is created at 16 and that is loaded into the prediction engine of 30. This feedback may be executed on a per transaction basis or after a certain of transactions have been accumulated. In other words, the model building process 12 is routinely repeated periodically or aperiodically so as to properly account for such external factors as macroeconomic trends, healthcare industry trends, regulatory changes, changes in provider/payer contracts, etc.

The account management process 10 of FIG. 1 is very flexible and can be used to make a variety of predictions such as the likelihood that an insurer or patient will make payment, the timing of such payment, whether claims will received at least an initial denial, what accounts are likely to be paid after a defined period of time has elapsed, which patients will qualify for which government programs, whether aged accounts might still be recoverable, etc.

FIG. 2 presents a specific application of the process of FIG. 1 directed to predicting payment dates for accounts. As shown in FIG. 2, an account management process 50 again involves two major components, a model building process 52 and an account level process 54. During the model building process 52, historical account-level data and outcomes are extracted at block 56.

At 58, the historical account-level data and outcomes are loaded into the statistical software SSPS, and an exhaustive CHAID analysis is run to derive a classification tree algorithm that predicts the desired outcome based on statistically significant data elements. In the case of FIG. 2, these data elements are those that are significant in predicting the number of days between billing and payment. Examples of such data elements are shown in a block 60 of FIG. 2. Those working in the pertinent domain have the knowledge to identify this data. Basically, everything that has the potential of being relevant/significant to predicting the payment date is fed into the SPSS, and the SPSS software analyzes which data is actually significant and discards non-significant data.

As shown the block 60, the data considered at 58 includes the identification of the insurer, the zip code of the insurer, the category of healthcare services rendered, financial class (contract, non-contract, managed government, managed care, etc.) of the arrangement that the healthcare provider has with the insurer, the expected reimbursements provided by the insurer, the type of insurance (HMO, PPO, etc.) provided to the patient by the insurer, the length of stay of the patient in the care facility, the managed care IPA (Independent Physician Association) group financially responsible for the patient's care (aka Primary Care Physician), the concerned department of the healthcare provider, the DRG (Diagnosis Related Group) primary illness category, whether the treatment was inpatient or outpatient, any pass through flags (such as though indicating that the contract with the insured requires copies of invoices for medical equipment), emergency or non-emergency services, the days from discharge when initial bills are submitted to the insured, etc.

At 62, the classification tree algorithm generated at 58 is exported from the statistical software SSPS and is loaded as a prediction engine, such as an MicroSegmentation™ engine, which is a software application of the account level process 54.

At 64, work strategies are loaded into a work flow engine of the account level process 54.

During the account level process 54, each new patient account billing entry is entered at 68 for processing. At 70, the prediction engine applies the classification tree algorithm in order to predict the date on which payment can be expected. At 72, the workflow engine applies business strategies to the predicted payment dates from 70 in order to drive the timing and type of account processing effort. At 74, the account level process 54 prevents employees of the healthcare provider from working accounts too early, i.e., too soon before the expected payment dates. At 76, the account level process 54 permits employees of the healthcare provider to work accounts only if unpaid after the predicted payment dates.

Although not shown, as in the case at 36 of FIG. 1, the actual experience that is derived from processing these accounts may be fed back as historical data in order to update the classification tree algorithm that is created at 58 and that is loaded as the prediction engine of the account level process 54.

As shown in FIG. 4, when the prediction engine is invoked at 30 of FIG. 1 (or 70 of FIG. 2), a decision is made at 80 to determine whether a new patient account entry (entered at 28 or 68) is an event that is linked to the model (classification tree algorithm) built by the model building process 12. There may be more than one model built by the model building process 12, including for example the model shown in FIG. 2, depending upon the desired output. The model described above in connection with FIG. 2 is one that is useful in predicting whether and when accounts are likely to be paid. If the event represented by the entry is not linked to a model, the process of the prediction engine ends at 82.

However, if the event represented by the entry is linked to a model as determined at 80, the event is matched at 84 to one of the models. For example, the model described above is one that is useful in determining whether patient accounts will be paid. Therefore, assuming that the event is connected with the payment of a patient account, the event matches the payment prediction model.

At 86, a determination is made as to whether processing of the event matching model is authorized. The check at 86 prevents the processing of the event and matching model that do not meet predefined criteria. For example, if it is predetermined that an event and matching model involving organization A is not to be processed and the event entered at 28 and the model matched at 84 to this event do involve organization A, processing of the event and matching model should be terminated. Therefore, if processing of the event and matching model is not authorized, processing is terminated at 82.

However, if processing of the event and matching model is authorized, processing is initiated at 88 to begin determining the X (predicted) value from the classification tree algorithm generated by the model building process 12. As shown in FIG. 4, X, in this example, is the rate at which it is expected to collect on the account currently being processed.

At 90, the processing initiated at 88 is started at node 0 of the model. The model is essentially a segmentation tree, and this tree is traversed beginning at 90. Thus, the prediction engine traverses through the nodes of the segmentation tree seeking a value for X by comparing the variables for each individual account to the criteria for each node.

As discussed above, FIG. 4 provides an example of a variable node index that illustrates tree traversal. The columns of the index include node ID, parent node ID, primary independent variable, split value, and percent good. The primary independent variables in this example are College (a variable indicating whether the patient with the account is a college graduate or not), Prevcoll (a variable indicating previous collections from this patient), Maxscore (a variable indicating the credit score for this person), Midcoll (a variable indicating previous partial payment on this account), Midcdoll001 (a variable indicating previous partial payment on this account), Sgbalafter (a variable indicating whether the person has insurance coverage or not), Priorviso (a variable indicating how many times the patient has been seen previously), Xfpbal04 (a variable indicating the balance due from the patient), etc. These variables in this example are determined to be relevant to the likelihood that patients accounts will be paid.

The split values are the values that split the corresponding variables. For example, if the person corresponding to the account being processed has not been to college (split value of 0) and has previous collections exceeding $4.885, then at this point X has a value of 57.61%. The split values and percentages in the last two columns of the index may be determined in any suitable manner. For example, a regression such as a linear regression may be applied to the historical data collected from a very large number of accounts in order to predict the likelihood of payment dependent upon the variables used in the regression.

Thus, the segmentation tree is traversed from node to node until, at 92, this traversal arrives at the end node of this branch. The X value at this end node is read at 92. In the example variable node index of FIG. 4, the value for X is 13.69% indicating that there is a 13.69% chance that the relevant account will be paid.

At 94, a value for Y is determined. The Y value, for example, may be the size of the account at the current time.

At 96, these X and Y values are used as addresses into a segment matrix in order to determine a segment code from the matrix. Because only two addresses are used, it is apparent that the segment matrix is a two dimensional matrix. FIGS. 3 and 4 provide an example of a two dimensional segment matrix. However, it is possible to use a segment matrix having more than two dimensions. For example, FIG. 4 includes the possibility of a third value, Z. This value, for example, might indicate the age of the account. A segment matrix having more than three dimensions could also be used. In the example, the segment code is A, B, C, or D. In general, the segment code is an identifier and could be any character value appropriate to distinguish the population.

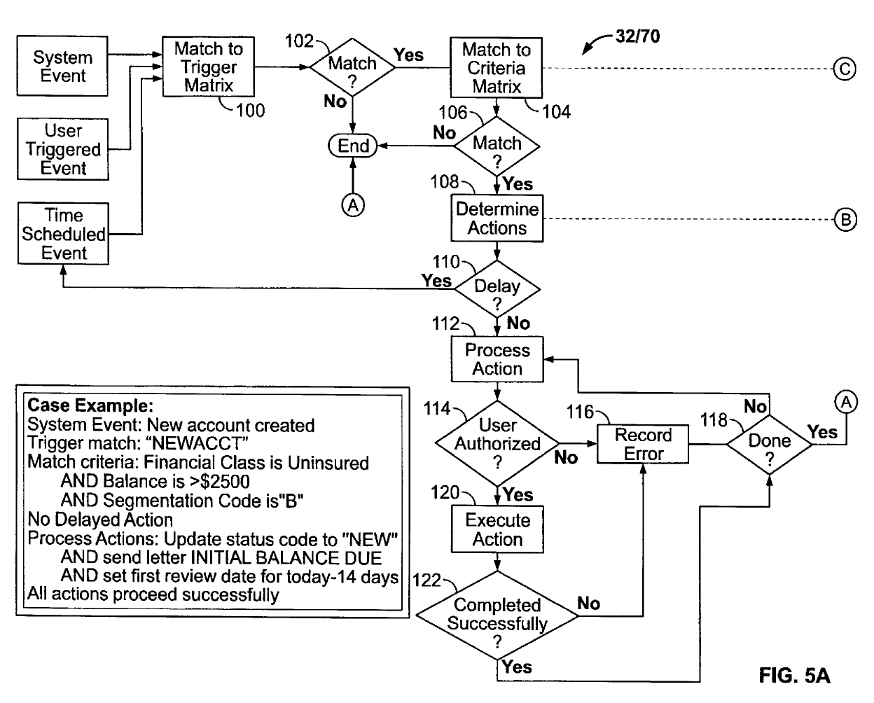

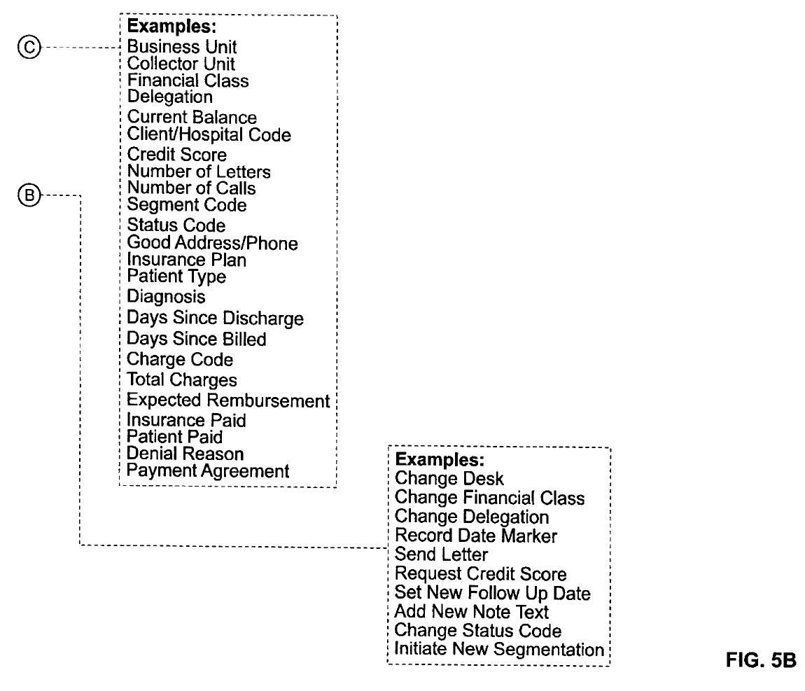

The segment code determined at 96 is used by the workflow engine as one of multiple possible criteria. As shown in FIG. 5, a trigger that initiates operation of the workflow engine is matched to a trigger matrix at 100. This trigger matrix determines the events that can legitimately initiate operation of the workflow engine.

Such events can be system events, user events, or time scheduled events. A system event may be the determination of a segment code at 96 of the prediction engine invoked at 30. A system event also may be an automated payment posting that will trigger operation of the workflow engine. Other examples of system events include receiving a credit score from a third party data provider, receiving an electronic claim status message from a payer, receiving an electronic notice of bankruptcy filing, etc.

A user event, for example, may be the entry by a user of account information that is to be processed. Examples of user events include reviewing and sending a claim to a payer, making a phone call attempt to a patient, documenting an action taken (or needing to be taken) to resolve an unpaid account, etc.

A time schedule event, for example, may be an action that is delayed by the workflow engine until a later date. Time scheduled events generally include phone call attempts, sending mail statements or letters, sending electronic data transactions to a payer. etc. This category of events does not require human intervention to initiate them.

If the event does not match a record in the trigger matrix as determined at 102, processing by the workflow engine terminates. However, if the event does match a record in the trigger matrix, then the event is matched at 104 to records in a criteria matrix. FIG. 5 gives examples of the types of criteria that can be used. Some examples of matches between an event and criteria are shown by box 105 of FIG. 5.

If the event does not match a record in the criteria matrix as determined at 106, processing by the workflow engine terminates. However, if the event does match a record in the criteria matrix, then a set of actions is determined at 108. A look up table may be used to determine the actions to be taken depending upon the data in the event. FIG. 5 gives examples of possible actions that can be taken.

A determination is made at 110 whether any of these actions require a delay. For example, a possible action might be to send a letter but to wait for three days until the letter is sent. If it is determined at 110 that any of the actions determined at 108 require a delay, then those actions requiring delay become a time scheduled event.

If it is determined at 110 that any of the actions determined at 108 require no delay, then processing of one of those actions requiring no delay is initiated at 112. At 114, a determination is made as to whether the user is authorized to take the action. Typically, this test is only needed for user triggered events. In this case, it is determined at 114 whether the user who triggered the event is authorized to take the action being initiated at 112.

If the user is not authorized to take the action whose processing is initiated at 112, then an error report is generated at 116 and a determination is made at 118 as to whether all actions that are determined at 108 and that require no delay have been processed. If all such actions have been processed, processing terminates. If such actions have not been processed, program flows returns to 112 to initiate processing of another action in the set determined at 108 that requires no delay.

If the user is authorized to take the action whose processing is initiated at 112, then the action is executed at 120. A determination is made at 122 as to whether the action is successfully completed. If not, processing of that action terminates and flow returns to 116 where an error record is generated. If the action is successfully completed, processing returns to 118 to determine if any more actions await processing.

As an example of an action that is not successfully completed, a time-delayed workflow event might be to send a letter, but when the time comes, the account has already been paid in full (thus no reason to send a letter).

In one embodiment, the account management process 10 and/or 50 can be executed by a machine such as a computer 150 shown in FIG. 6. The computer 150 includes a processor 152, a memory 154, an input 156, and an output 158. The processor 152 executes the account management process 10 and/or 50, which is stored in the memory 154, along with the data required for execution of the account management process 10 and/or 50. The memory 154 may be a hard drive, a flash memory, a floppy drive, a CD and/or DVD drive, and/or any other suitable memory device that stores the account management process 10 and/or 50 and the data required for execution of the account management process 10 and/or 50. The input 156 may be a mouse, a keyboard, a disk drive and/or other device that can be used by a user to input the account management process 10 and/or 50 and the data required for execution of the account management process 10 and/or 50. The output 158 may be a display, a printer, a disk drive and/or other device that can be used to provide the various outputs and to execute various actions described above.

However, the account management process 10 and/or 50 can be performed or executed on other devices such as an ASIC, programmable field arrays, dedicated circuits, etc.

Modifications of the present invention have been discussed above. Other modifications of the present invention will occur to those practicing in the art of the present invention. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A method of predicting an outcome of processing a healthcare patient account, the method implemented by a machine, the method comprising:
receiving an entry regarding the healthcare patient account;
processing the healthcare patient account in response to the entry, wherein the processing includes executing an outcome prediction model to convert the entry into a prediction of the outcome of the processing of the healthcare patient account; and,
providing the predicted outcome to a user.

2. The method of claim 1 wherein the executing of an outcome prediction model comprises traversing a segmentation tree based on a plurality of variables associated with the entry or the healthcare patient account.

3. The method of claim 2 wherein the traversing of a segmentation tree comprises producing a first value related to the predicted outcome, and wherein the method further comprises:
determining a second value related to the predicted outcome; and,
addressing a prediction outcome segment matrix in accordance with the first and second values so as to determine a segment that indicates the predicted outcome.

4. The method of claim 3 wherein the providing of the predicted outcome to a user comprises determining account collection strategies based on the segment indicating the predicted outcome.

5. The method of claim 1 wherein the predicted outcome relates to when the healthcare patient account will be paid.

6. The method of claim 1 wherein the predicted outcome relates to whether the healthcare patient account will be paid.

7. The method of claim 1 wherein the predicted outcome relates to whether payment of the healthcare patient account will be at least initially denied.

8. The method of claim 1 wherein the predicted outcome relates to whether the healthcare patient account will be paid after a defined time period.

9. The method of claim 1 wherein the predicted outcome relates to whether a patient will qualify for a government sponsored program regarding healthcare.

10. The method of claim 1 wherein the providing of the predicted outcome to a user comprises determining account collection strategies based on the predicted outcome.

11. The method of claim 10 wherein the account collection strategies includes an action that can be taken to collect on the healthcare patient account, and wherein the determining of account collection strategies based on the predicted outcome comprises:
receiving an event related to triggering the action; and,
determining whether the event can legitimately initiate operation of the action.

12. The method of claim 10 wherein the account collection strategies includes an action that can be taken to collect on the healthcare patient account, and wherein the determining of account collection strategies based on the predicted outcome comprises:
determining whether the action should be delayed; and,
scheduling the action for further execution if the action should be delayed.

13. A method of generating a healthcare patient account processing outcome prediction model, the method implemented by a machine, the method comprising:
receiving historical healthcare patient account related data; and,
converting the historical healthcare patient account related data into the healthcare patient account processing outcome prediction model, wherein the healthcare patient account processing outcome prediction model is executable by a machine to predict an outcome of processing a healthcare patient account.

14. The method of claim 13 wherein the healthcare patient account processing outcome prediction model is a software engine executable by a machine to predict an outcome of processing a healthcare patient account.

15. The method of claim 14 wherein the software engine comprises a segmentation tree that is traversable based on a plurality of variables.

16. The method of claim 15 wherein traversing of the segmentation tree comprises producing a first value related to the predicted outcome, and wherein the method further comprises:
determining a second value related to the predicted outcome; and,
addressing a prediction outcome segment matrix in accordance with the first and second values so as to determine a segment that indicates the predicted outcome.

17. The method of claim 16 wherein traversing of the segmentation tree further involves:
determining a second value related to the predicted outcome; and,
addressing a prediction outcome segment matrix in accordance with the first and second values so as to determine a segment that indicates a predicted outcome with respect to the healthcare patient account.

18. The method of claim 17 further comprising generating account collection strategies invocable following execution of the healthcare patient account processing outcome prediction model.

19. The method of claim 13 wherein the healthcare patient account processing outcome prediction model is executable to predict when the healthcare patient account will be paid.

20. The method of claim 13 wherein the healthcare patient account processing outcome prediction model is executable to predict whether the healthcare patient account will be paid.

21. The method of claim 13 wherein the healthcare patient account processing outcome prediction model is executable to predict whether payment of the healthcare patient account will be at least initially denied.

22. The method of claim 13 wherein the healthcare patient account processing outcome prediction model is executable to predict whether the healthcare patient account will be paid after a defined time period.

23. The method of claim 13 wherein the healthcare patient account processing outcome prediction model is executable to predict whether a patient will qualify for a government sponsored program regarding healthcare.

24. The method of claim 13 further comprising generating account collection strategies invocable following execution of the healthcare patient account processing outcome prediction model.

25. The method of claim 24 wherein the account collection strategies includes an action that can be taken to collect on the healthcare patient account, and wherein the action is triggerable by an event but only if the event can legitimately initiate operation of the action.

26. The method of claim 24 wherein the account collection strategies includes an action that can be taken to collect on the healthcare patient account, and wherein the action can be either an action that can be immediately executed or executed only after a delay.
